(19) United States
(12) Patent Application Publication
(10) Pub. No.: US 2015/0158186 A1
(43) Pub. Date: Jun. 11, 2015

(54) SCARA ROBOT

(71) Applicant: HIWIN TECHNOLOGIES CORP., Taichung City (TW)

(72) Inventors: Yung-Tsai CHUO, Taichung City (TW); Fu-Ching WANG, Taichung City (TW); Tsung-Ying LIN, Taichung City (TW)

(73) Assignee: HIWIN TECHNOLOGIES CORP., Taichung City (TW)

(21) Appl. No.: 14/256,505

(22) Filed: Apr. 18, 2014

(30) Foreign Application Priority Data
Dec. 10, 2013 (TW) 102145410

(51) Int. Cl. B25J 18/04

(52) U.S. Cl. CPC B25J 18/04; G05B 2219/40301

(57) ABSTRACT

A SCARA robot includes a base, a first arm mounted at the base and rotatable on a first imaginary axis, a second arm mounted at the first arm and rotatable on a second imaginary axis, a shaft motor including a fixing member mounted in the second arm and an axle movable relative to the fixing member along a third imaginary axis that is substantially parallel with the first and second imaginary axes, and a rotary motor mounted in the second arm and adapted for rotating the axle on the third imaginary axis. Thus, the SCARA robot facilitates operational control, improves operational precision, voids quick wear of component parts, and lowers maintenance costs.

### BACKGROUND OF THE INVENTION

1. Field of the Invention

The present invention relates to robotic technology, and more particularly, to a SCARA robot.

2. Description of the Related Art

Taiwan Patent 201242731 discloses a SCARA robot, which comprises a base, a first arm mounted at the base, a second arm mounted at the first arm, and an axle vertically inserted through the second arm. The first arm is rotatable by a first motor in the base. The second arm is rotatable by a second motor therein. The axle is drivable to rotate and to move axially by a complicated drive mechanism.

In detail, the axle is a ball screw with splines. The second arm has mounted therein an axle drive that comprises two motors, two belts, and a spline nut and a ball nut sleeved onto the axle. The spline nut and the ball nut are respectively rotatable by the two motors through the two belts. Thus, rotation of the spline nut drives the axle to rotate; rotation of the ball nut drives the axle to move axially.

However, due to indirect driving, the aforesaid axle drive has low efficiency. Further, it is difficult to maintain the tensions of the belts constantly for a long time. The transmission efficiency will become instable if the tensions of the belts are changed. Further, the belts can impart a lateral force to the axle, causing axle deviation and lowering axle positioning precision. Further, when the axle is being rotated by the spline nut, the ball nut must be properly controlled subject to the rotation of the axle so as to prevent displacement of the axle or to have the axle be moved axially to the desired position. In consequence, the control of the axle drive is complicated. Further, the structure of the axle drive is complicated, thus it is more difficult to replace the component parts of the axle drive, for example, it needs to dismount many other parts when replacing the belts, increasing maintenance costs

### SUMMARY OF THE INVENTION

The present invention has been accomplished under the circumstances in view. It is the main object of the present invention to provide a SCARA robot, which directly drives the terminal axle, facilitating operational control, improving operational precision, voiding quick wear of component parts, and greatly lowering maintenance costs.

To achieve this and other objects of the present invention, a SCARA robot of the invention comprises a base, a first arm, a second arm, a shaft motor, and a rotary motor. The first arm is mounted at the base and rotatable on a first imaginary axis. The second arm is mounted at the first arm and rotatable on a second imaginary axis that is substantially parallel with the first imaginary axis. The shaft motor comprises a fixing member mounted in the second arm, and an axle movable relative to the fixing member along a third imaginary axis that is substantially parallel with the first imaginary axis. The rotary motor is mounted in the second arm, and adapted for rotating the axle on the third imaginary axis.

Thus, the invention directly drives the axle without through a belt or any other transmission means, assuring a high level of operational stability and preventing deviation of axle due to lateral force from a transmission belt. Further, the displacement control and rotation control for the axle do not interfere with each other. Therefore, the invention facilitates operational control, improves operational precision, voids quick wear of component parts, and lowers maintenance costs.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a SCARA robot in accordance with the present invention.

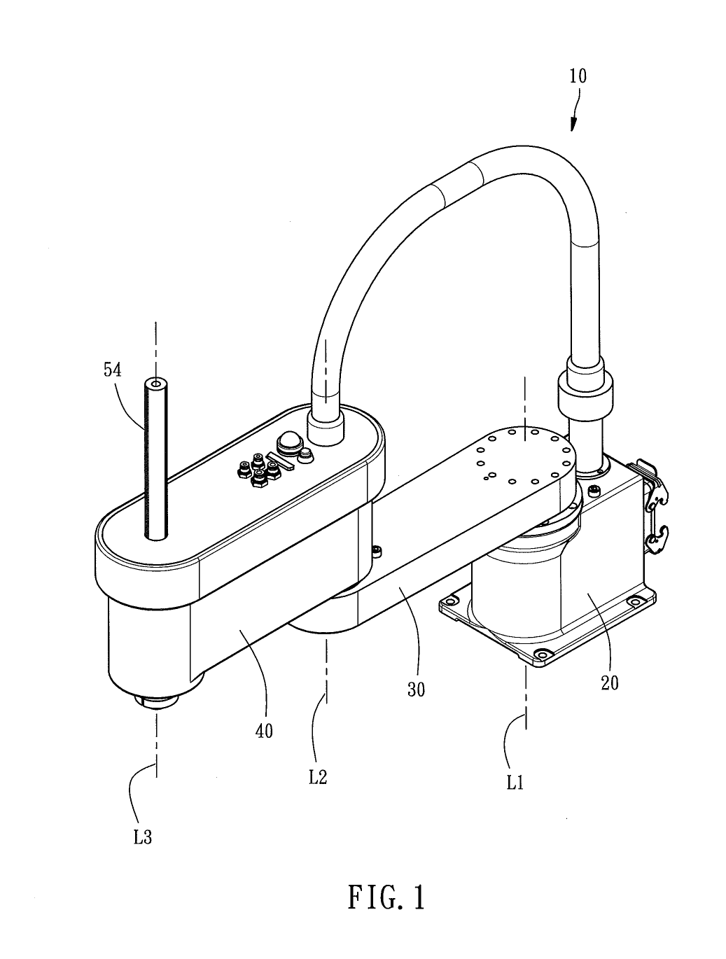

FIG. 2 is a sectional side view of the SCARA robot in accordance with the present invention.

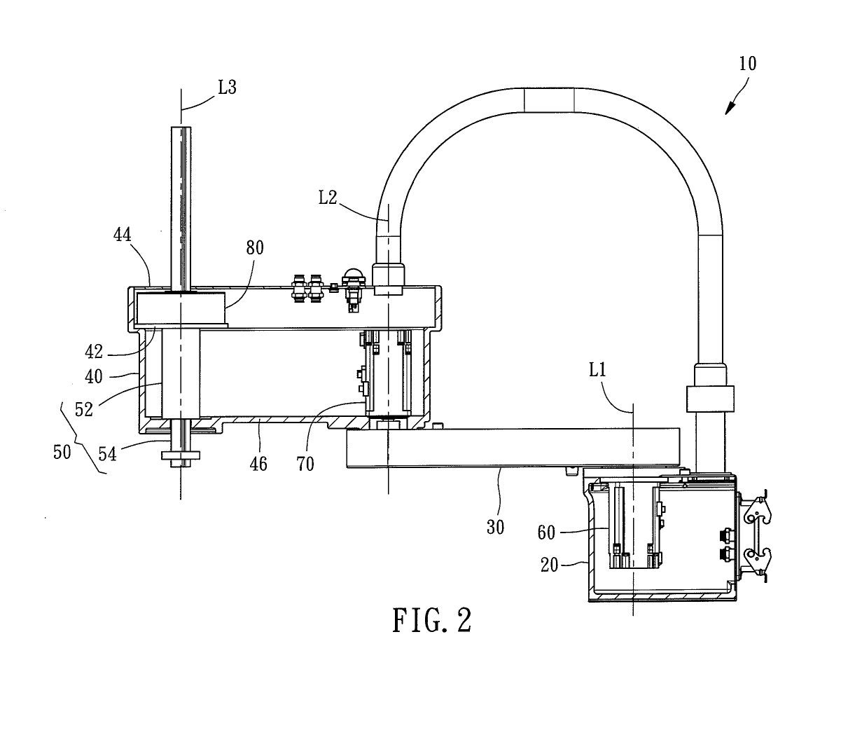

FIG. 3 is an exploded view of the rotary motor, socket, partition board and shaft motor of the SCARA robot in accordance with the present invention.

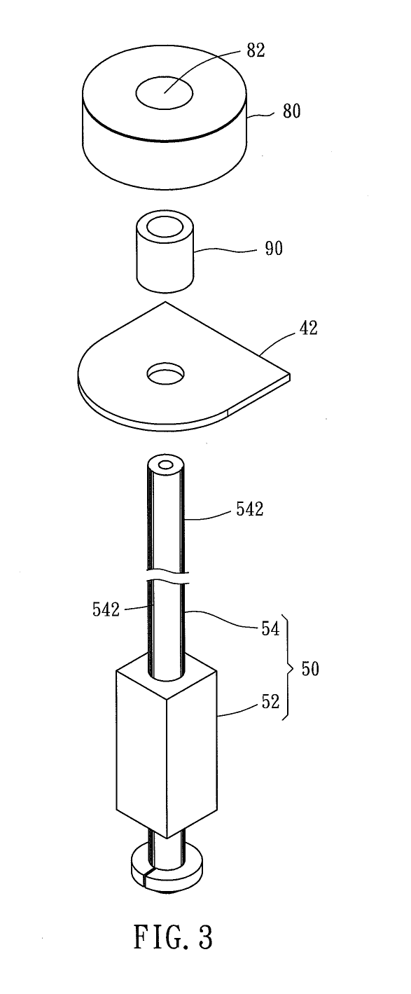

### DETAILED DESCRIPTION OF THE INVENTION

Referring to the annexed drawings in detail, a SCARA robot 10 comprises a base 20, a first arm 30, a second arm 40, a shaft motor 50, three rotary motors 60, 70 and 80, and the socket 90.

The first arm 30 has one end thereof mounted at the base 20. The rotary motor 60 is mounted in the base 20, having an output shaft (not shown) vertically upwardly connected with the first arm 30 for rotating the first arm 30 on a first imaginary axis L1 relative to the base 20.

The second arm 40 has one end thereof mounted at an opposite end of the first arm 30. The rotary motor 70 is mounted in the second arm 40, having an output shaft (not shown) vertically downwardly connected with the first arm 30. Thus, the rotary motor 70 is capable of turning the second arm 40 about a second imaginary axis L2 relative to the first arm 30. Further, the second imaginary axis L2 is substantially parallel with the first imaginary axis L1.

The shaft motor 50 comprises a rectangular columnar fixing member 52, and a cylindrical axle 54. The fixing member 52 is fixedly mounted in the second arm 40 with a partition board 42. The axle 54 is inserted through the fixing member 52 and extended out of opposing top panel 44 and bottom panel 46 of the second arm 40. During rotation of the shaft motor 50, the axle 54 is moved along a third imaginary axis L3 relative to the fixing member 52. Further, the third imaginary axis L3 is substantially parallel with the first imaginary axis L1 and the second imaginary axis L2.

The rotary motor 80 has a different configuration relative the aforesaid two other rotary motors 60 and 70, having a through hole 82 at the center. The socket 90 is fixedly mounted in the through hole 82 and rotatable by the rotary motor 80. The rotary motor 80 and the socket 90 are mounted inside the second arm 40 between the top panel 44 and the partition board 42. The axle 54 is inserted through the socket 90 and peripherally coupled with an inner surface of the socket 90, thus, the axle 54 is rotatable with the socket 90 on the third imaginary axis L3.

In this embodiment, the axle 54 has a plurality of grooves 542 substantially parallel with the third imaginary axis L3. The axle 54 is coupled with the socket 90 by means of the grooves 542, for example, the socket 90 can be made having cycle path rolling grooves (not shown) disposed in the inner surface thereof, and a plurality of rolling balls (not shown) can be respectively mounted in between the cycle path rolling grooves and the grooves 542. Alternatively, the socket 90 can made having ribs (not shown) disposed in the inner surface thereof and respectively coupled to the grooves 542. However, it is to be noted that the configuration of the rotary motor 80 and the coupling arrangement between the rotary motor 80 and the axle 54 are not limited to the design described in the present preferred embodiment, any of a variety of other measures capable of enabling the rotary motor 80 to rotate the axle 54 on the third imaginary axis L3 can be selectively used.

Because the invention directly uses the axle 54 of the shaft motor 50 as the terminal axle of the SCARA robot 10 and enables the axle 54 to be driven by the rotary motor 80 directly, the direct driving method of the present invention, when compared to conventional indirect driving methods using a belt transmission mechanism or other transmission means, has the advantage of high efficiency and can avoid the problem of transmission instability caused by changes in the tension of the transmission belt. Therefore, the invention enhances the stability of the motion of the axle 54, and prevents deviation of axle 54 due to lateral force from a transmission belt. Further, the displacement control and rotation control for the axle 54 do not interfere with each other. Therefore, the invention facilitates operational control, improves operational precision, voids quick wear of component parts, and lowers maintenance costs.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A SCARA robot, comprising:
a base;
a first arm mounted at said base and rotatable on a first imaginary axis relative to said base;
a second arm mounted at said first arm and rotatable on a second imaginary axis relative to said first arm, said second imaginary axis being substantially parallel with said first imaginary axis;
a shaft motor comprising a fixing member mounted at said second arm and an axle movable along a third imaginary axis relative to said fixing member, said third imaginary axis being substantially parallel with said first imaginary axis; and
a rotary motor mounted in said second arm and adapted for rotating said axle on said third imaginary axis.

2. The SCARA robot as claimed in claim 1, wherein said rotary motor comprises a through hole, and a socket mounted in said through hole and coupled with said axle and drivable by said rotary motor to rotate said axle

3. The SCARA robot as claimed in claim 2, wherein said axle comprises at least one groove disposed substantially parallel with said third imaginary axis and coupled with said socket.
